(19) United States
(12) Patent Application Publication
(10) Pub. No.: US 2004/0175045 A1
(43) Pub. Date: Sep. 9, 2004

(54) System of combinable patterns that generates artful designs

(76) Inventor: Pablo Fernando Cha, Montevideo (UY)

Correspondence Address: Pablo Cha, Apt. 5, 916 S. New Hampshire, Los Angeles, CA, 90006, US

(21) Appl. No.: 10/792,627

(22) Filed: Mar. 2, 2004

Related U.S. Application Data
(60) Provisional application No. 60/451,651, filed on Mar. 4, 2003.

(51) Int. Cl. G06K 9/62

(52) U.S. Cl. 382/209

(57) ABSTRACT

A system of combinable patterns that generates artful designs, where pattern-matching is automatic and unavoidable by virtue of the design of the single patterns.

The number of pieces could change, however, the design shown on each and every piece will correspond to one of a set comprised of six different single patterns which act as the generator set. These single patterns are designed through a precise and rigorous logical process.

These system of patterns can be embodied in many different objects, from puzzle-like objects, to decorative design for tiles, as a computer game, etc.

I am claiming the benefit of the filing date of provisional application No. 60/451,651 filed Mar. 4, 2003.

### BACKGROUND

1—Field of Invention

This invention relates to sets of combinable patterns whose aim is to generate different designs by using a few elemental basic units. It also relates to puzzles, offering a medium challenge. However, the main object of this invention is to offer an aesthetic and joyful experience.

2—Discussion of Prior Art

From the perspective of our invention, the puzzles and sets of combinable patterns that we have researched present certain inherent limitations.

There are many examples of sets of patterns that allows the player to reproduce a given image, or generate his or her own. In most of them the different patterns do not always match with each other, and though some are interesting, they lack the organic feeling and perceptible wholeness. (161,423, −3,464,145, graham). In our invention, pattern-matching is automatic and unavoidable by virtue of the design of the pieces.

There are a few sets of combinable pieces that play with the idea of automatic and unavoidable pattern-matching. However, they lack the powerful aesthetic and logic appeal of our invention, that come from using a set of patterns created through a precise and rigorous logical process. (3,643,956 and 4,180,271

Regarding puzzles, its main object is to be challenging. From very simple to highly complex, the object is to solve some problem, to find the right arrangement of the pieces. (by Stein et al, U.S. Pat. No. 4,361,328 (1982); and Clark, U.S. Pat. No. 4,410,180 (1983).) Our main goal is to entertain, to facilitate an aesthetic experience and to provide a tool to explore peoples' own creativity.

In U.S. Pat. No. 5,692,749, we are presented with a very interesting puzzle, closer to our set in beauty and perceptible wholeness. The images this puzzle can assemble present a strong fluidity and organic feeling, because the underlying logic and mathematic criteria they use to create the pieces. However, these principles are too open, and the designer could create within the set as many basic units as he or she wants following this criteria. In our invention, the generating pattern it is comprised of six, and no more, different elemental units. (we can change the generating pattern by changing the basic curve that it is used as primordial element, thus creating different families of generating patterns. However each family comprised just six different basic patterns). Furthermore, the object of the puzzle in U.S. Pat. No. 5,692,749, is to provide a challenging puzzle, so they do not encourage to freely explore a universe of beauty.

### BRIEF SUMMARY OF THE INVENTION

A set of combinable patterns that can be arranged to depict prescribed or original designs.

A set of combinable patterns where pattern-matching is automatic and unavoidable by virtue of the design of the single patterns.

A set of combinable patterns in which the single patterns stem from a precise and rigorous logical process.

A set of combinable pieces in which any arrangement of the pieces, will display a new design of consistency, beauty and harmony.

A set of combinable pieces that can be used as a puzzle of medium challenge.

A set of combinable patterns able to be embodied as an artifact that entertains, and allows the player to explore a creative and joyful state of mind.

A tool for developing geometric and logical skills, a didactic toy.

An open-ended system for exploring planar and three dimensional design.

An artifact that can be used as a game apparatus where two or more players could work jointly or against each other to create a design.

A set of patterns that can be used as the decorative designs on different objects, such as tiles, furniture, etc. allowing each person to create his or her favorite design.

A set of combinable patterns requiring relatively few pieces and a small work space, allowing small, compact, and easily portable embodiments.

### BRIEF DESCRIPTION OF THE SEVERAL VIEWS OF THE DRAWING

FIG. 1 shows the preferred embodiment of nine cubes depicting the different patterns.

FIG. 2 shows the first stage in the process of creating each one of the singular patterns, using an arc of circumference shaped band as the primordial element.

FIG. 3 shows pattern 1

FIG. 4 shows pattern 2

FIG. 5 shows pattern 3

FIG. 6 shows pattern 4

FIG. 7 shows pattern 5

FIG. 8 shows pattern 6

FIG. 9 shows all six patterns that act as the generator set for the system

FIG. 10 shows another set of generating patterns where the primordial element to construct such set was a straight band instead of an arc of circumference.

FIG. 11 shows a variety of different images that can be assembled with this system of patterns.

### DETAILED DESCRIPTION OF THE INVENTION

This invention is a system of combinable patterns that generates artful designs, where pattern-matching is automatic and unavoidable by virtue of the design of the single patterns. The number of pieces could change. However, they are all squares of the same measures and present a specific design on its surface. The designs shown on each and every piece will correspond to one of a set comprised of six different single patterns which act as the generator set: These single patterns are designed through a precise and rigorous logical process.

The basic idea is that we will use just two simple shapes (a regular band, and a “concluding shape”) as the primordial elements to generate all the different designs by placing them in all the possible positions in a square, within the guidelines we specify bellow.

The first consideration is that we make pattern-matching automatic and unavoidable by placing on the center of every edge of each square used as the surface for designing the single patterns, the termination of at least one of the basic shapes used to create the whole set. Thus we achieve continuity from one piece to the next one.

Description of Each Pattern

Pattern 1

On a square (FIG. 2), we draw a band that runs from the center of one side (a), to the center of an adjacent side (b). This band could adopt any shape, though arcs of circumference (and a straight band) present the more appealing look. Solely for the purpose of exemplification we will use now a circular shaped band which center lies in the corner where the two said edges joint and its width equal to the third part of the side of the square.

In addition to this element, we place in the center of the “empty” sides a small shape that will work (visually speaking) as the “end” of a given curve (such curve coming from an adjacent piece) (FIG. 3). By doing so, that curve will “conclude” smoothly instead of just being sharply interrupted. In the present example where we are using “circular shaped bands”, the best formulation is achieved by using half circles of diameter equal to the width of the band.

Note that either one extreme of the band or a half circle as described above, is placed on every side of the square.

If we draw this band between any two other adjacent sides of the square, we will obtain the same design described above. (this could be noticed by rotating this second piece until it is in the same position than the first). So, when we use only one band to create the design, we can only obtain just one single pattern.

Pattern 2

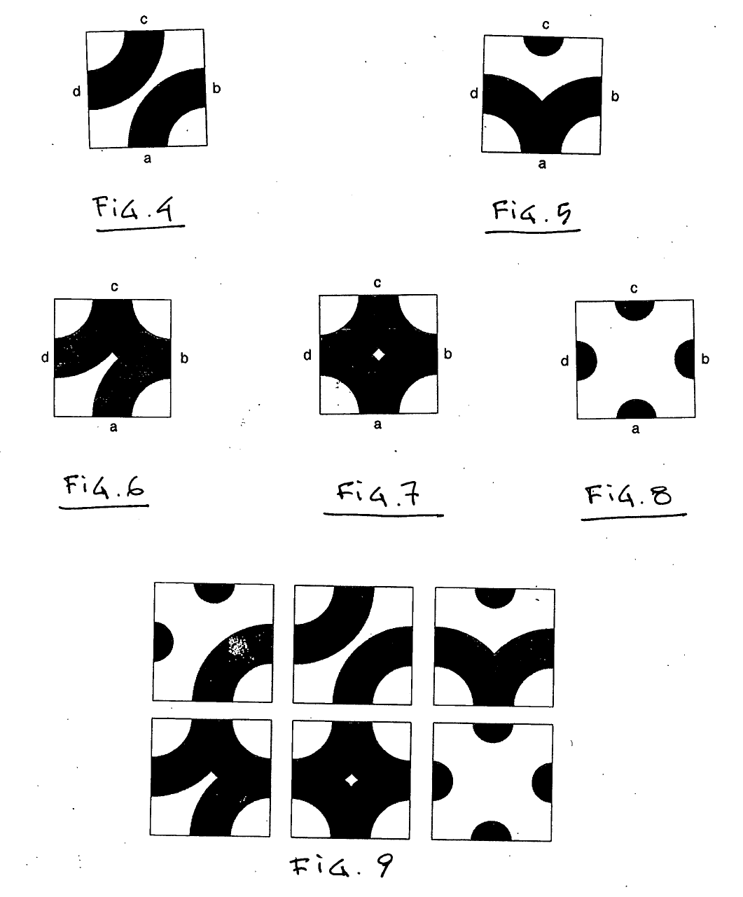

It has two bands and not small half circles. One band runs from “a” to “b”, and the other from “c” to “d”. (FIG. 4)

If we place the bands from “a” to “d”, and from “b” to “c”, we will obtain the same design described. (it could be notice by rotating one of the squares 90 degrees). But in this case, we could have a different design if we allow the two bands to cross each other, as shown in pattern 3.

Pattern 3

It shows two bands that merge toward the “a” side. One band runs from “d” to “a”, and the other from “a” to “b”. on the “c” side we have a half circle. (FIG. 5)

A simple analysis will show that using two bands we could obtain either pattern 2 or pattern 3, and not a different one.

Pattern 4

It shows three bands that merge together. One from “a” to “b”, one from “b” to “c”, and one from “c” to “d” (FIG. 6). All the designs that could be created using three bands are the same that pattern 4.

Pattern 5

It shows four bands that merge together. One from “a” to “b”, one from “b” to “c”, one from “c” to “d” and one from “d” to “a” (FIG. 7). Again, there is just one design with four bands.

Pattern 6

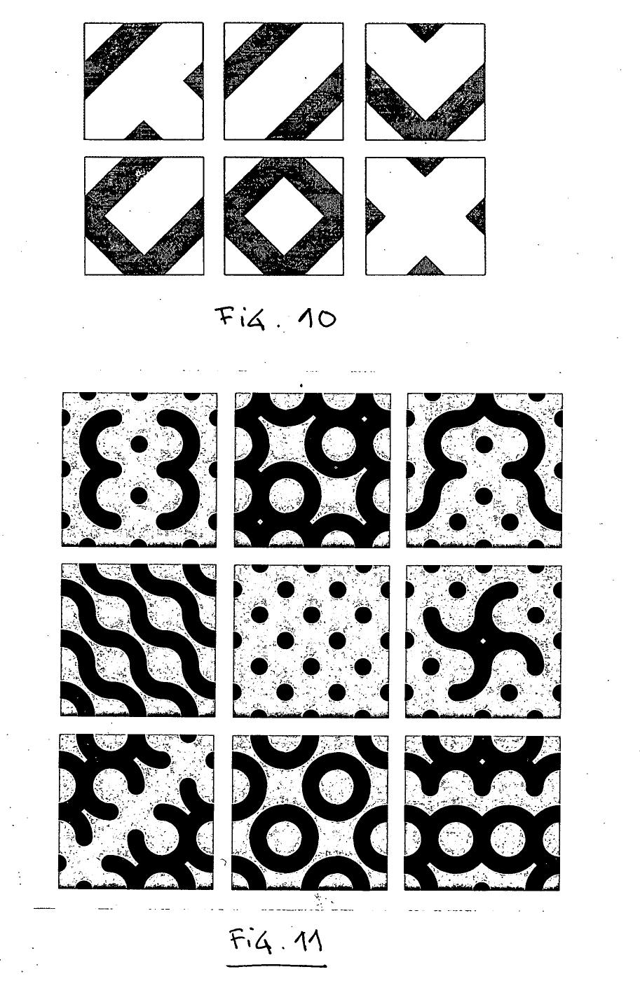

This pattern has no bands. It just has four “half circles” every one placed on the center of each edge (FIG. 8).

It is important to notice that following this specific process to obtain the generating set for the system we obtain six different single patterns and no more. It is not up to the designer but an inherent characteristic of the process. This feature rather to be a limitation is what gives the system its strong consistency, beauty and harmony.

FIG. 9 depicts the six different designs that comprised the generating set.

In FIG. 11 are shown a few different images from the billions that can be assembled with this system of patterns.

By changing the parameters of the primordial elements of this process, we will obtain countless different generating sets, all consisting of just six different designs. In order to have an idea of the scope of this invention we can think of the primordial shapes (bands, half-circles) as “molecules”; each single pattern created with this “molecules” as “cells”, and the images obtainable with such set of “cells” as “organisms” all pertaining to the same “specie”. Different primordial bands will create different cells which in turn will originate different kind o organisms. As an example of that we provide another “generating pattern” obtained when using straight bands. (FIG. 10)

### DESCRIPTION OF THE PREFERRED EMBODIMENT

This invention readily lends itself to many different embodiments, from puzzle-like toys, to computer games, etc. They could be used as the decorative adornment of tiles, furniture, fabrics, etc.

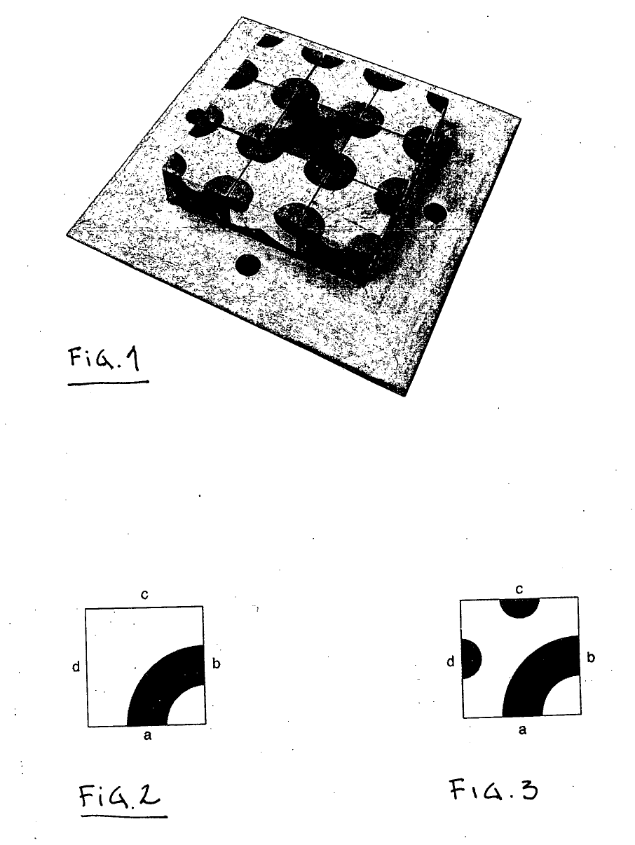

The preferred embodiment of this invention, illustrated in FIG. 1, is a set of nine identical cubes which display on each one of its faces a different pattern as the ones described above. Since a cube has six faces, and there are just six possible different patterns (on each “specie”), we believe this embodiment is the most elegant and powerful. The amount of possible images that can be formed with this set is 68,719,476,736 if we choose the shape of a square (3 rows of 3 cubes each). In addition, many other countless shapes can be formed.

Furthermore, the cubes could be arranged in a spatial configuration allowing the assembling of sculpture-like art-objects, where the patterns will still match throughout the whole arrangement. Obviously, there can be sets with larger number of pieces (16, 25, etc). We consider nine as the minimum number of cubes necessary for phenomenon, logic and aesthetic, that is being generated.

In the preferred embodiment, the set comes with a board where the pieces are displayed, and a booklet showing different examples of designs to reproduce.

Alternate Embodiments.

A tiling, set of combinable patterns, where the pieces are flat squares that could be made out of wood, plastic, metal, cardboard, etc. In particular we want to refer to an embodiment where the pieces are flat squares of a magnetic sheet material that could come with a metallic board or without, being suitable for the door of the refrigerator, etc.

There is a big potential to develop a digital version that could be played over the internet, on personal computers, etc, as a game, as a screen saver, as an interactive animation, etc.

Many other variations are feasible. The above descriptions should not be construed as limiting the scope of my invention, but rather as simply illustrating a few of its many possible embodiments.

I claim:

1. A system of combinable patterns that can be arranged to depict prescribed or original artful designs, where pattern-matching is automatic and unavoidable by virtue of the design of the single patterns
the design shown on each and every piece will correspond to one of a set consisting of six different single patterns which act as the generator set
these single patterns are designed through a precise and rigorous logical process.

2. the system of patterns of claim 1 wherein one of said patterns is a square that shows a regular band that runs from the center of one edge of the square to the center of an adjacent edge, having in the centers of the other two edges a small shape that will work as the end of any given curve.

3. the system of patterns of claim 1 wherein one of said patterns is a square that shows two regular bands, one running from the center of one edge of the square to the center of an adjacent edge, and the other band running between the centers of the other two edges of the square.

4. the system of patterns of claim 1 wherein one of said patterns is a square that shows two regular bands that run simultaneously from the centers of opposite edges and merge together in the center of a third edge of the square.

5. the system of patterns of claim 1 wherein one of said patterns is a square that shows three regular bands each one running between the centers of two different adjacent edges.

6. the system of patterns of claim 1 wherein one of said patterns is a square that shows four regular bands each one running between the centers of two different adjacent edges

7. the system of patterns of claim 1 wherein one of said patterns is a square that shows no bands and a small shape on every center of ecery edge that will work as the end of any given curve.

8. the system of patterns of claim 1 that can be used as a puzzle of medium challenge.

9. the system of patterns of claim 1 that can be used as a tool for developing geometric and logical skills.

10. the system of patterns of claim 1 that can be used as an open-ended system for exploring planar and three dimensional design.

11. the system of patterns of claim 1 able to be embodied as an artifact that entertains, and allows the player to explore a creative and joyful state of mind.

12. the system of patterns of claim 1 that can be embodied as an artifact that can be used as a game apparatus where two or more players could work jointly or against each other to create a design.

13. the system of patterns of claim 1 that can be used as the decorative designs on different objects, such as tiles, furniture, etc. allowing each person to create his or her favorite design.

14. a set of several identical cubes which display on each one of its faces a different pattern of the system of patterns of claim 1.
